(19) United States
(12) Patent Application Publication
(10) Pub. No.: US 2009/0019355 A1
(43) Pub. Date: Jan. 15, 2009

(54) Method and System for Analyzing Patent Family Information

(76) Inventors: Herb Jiang, Sinjhuang City (TW); Jen-Diann Chiou, Taipei City (TW); Jerry Tang, Taipei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/775,892

(22) Filed: Jul. 11, 2007

(51) Int. Cl. G06F 3/14; G06F 17/30; G06F 7/06

(52) U.S. Cl. 715/227; 707/5; 707/E17.008; 707/E17.017

(57) ABSTRACT

A method for analyzing patent families. The method comprises: receiving a patent publication number; retrieving a family data set for the patent publication number, where the family data set includes a plurality of family member data sets, where each family member data set is related to the patent publication number and where each family member data set includes a publication number and country; storing the family data set; and graphically displaying a relationship between two or more of the plurality of family member data sets in the family data set.

### FIELD OF THE INVENTION

The method and system disclosed relate to the field of patent analysis, and more specifically, a system for and method of analyzing global patent deployment using patent family information.

### BACKGROUND

Patent databases, such as those provided by the U.S.P.T.O. and the E.P.O, provide patent family data for patents and published patent applications. This patent family data includes listings of related patents and publications. Related patents and publications may include patents related by domestic claims of priority (for example, continuations) and patents related by international claims of priority. If provided with a patent number, these databases can retrieve listings of related patents and publications. However, these databases provide only rudimentary retrieval with no analysis. For example, theses databases do not provide for illustrating the patent families by year of publication or issue, or by patent classification.

The present invention addresses the above problems and is directed to achieving at least one of the above stated goals.

### SUMMARY

A method for analyzing patent families is disclosed. The method comprises: receiving a patent publication number; retrieving a family data set for the patent publication number, where the family data set includes a plurality of family member data sets, where each family member data set is related to the patent publication number and where each family member data set includes a publication number and country; storing the family data set; and displaying a relationship between two or more of the plurality of family member data sets in the family data set.

In accordance with a further embodiment, a system for analyzing patent families is provided. The system comprises a memory and a processor coupled to the memory. The processor is operable to: receive a company set including an entity name; receiving a patent publication number; retrieve a family data set for the patent publication number, where the family data set includes a plurality of family member data sets, where each family member data set is related to the patent publication number and where each family member data set includes a publication number and country; store the family data set; and graphically display a relationship between two or more of the plurality of family member data sets in the family data set.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the principles of the invention and, together with the description, serve to explain the principles of the invention.

FIG. 1 is a flowchart of a method of analyzing patent families consistent with the present invention.

FIG. 2 is a flowchart of a method of retrieving patent family data sets consistent with the present invention.

FIG. 3 is a graphical display of patent family data illustrating the count and publication number of patent family members consistent with the present invention.

FIG. 4 is a graphical display of patent family data illustrating the issue dates of patent family members consistent with the present invention.

FIG. 5 is a graphical display of patent family data illustrating the international patent classification number of patent family members consistent with the present invention.

FIG. 6 is a block diagram of a patent family analysis platform consistent with the present invention.

### DESCRIPTION

A patent family analysis platform is described herein. The patent family analysis platform analysis patents that are members of the same patent family. A patent family may comprise one or more patents or patent applications that are related. Related patents may be patents that have some claim of priority shared among them. For example, two U.S. patents may be members of the same patent family where a first is related to a second through, for example, continuations, divisionals, or continuations-in-part. Patents of different countries may be related through claims of priority. An analysis of patent family data may yield information on the global reach of patent families, or on the range of technologies represented within the patent family. As another example, studying a patent family may demonstrate the continuity over a period of time between members of a patent family. By graphically displaying information about patent families to a user, the user is informed of the breadth of a patent family, either globally, temporally, or technically.

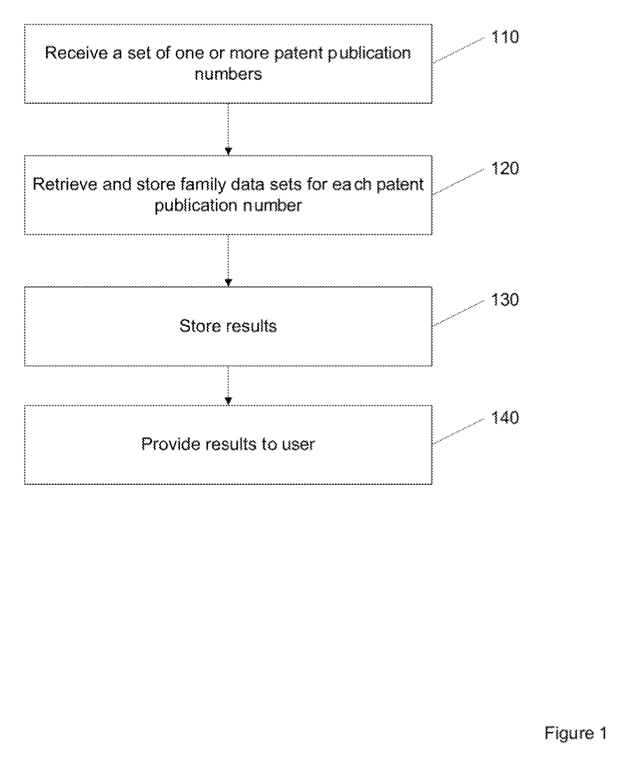

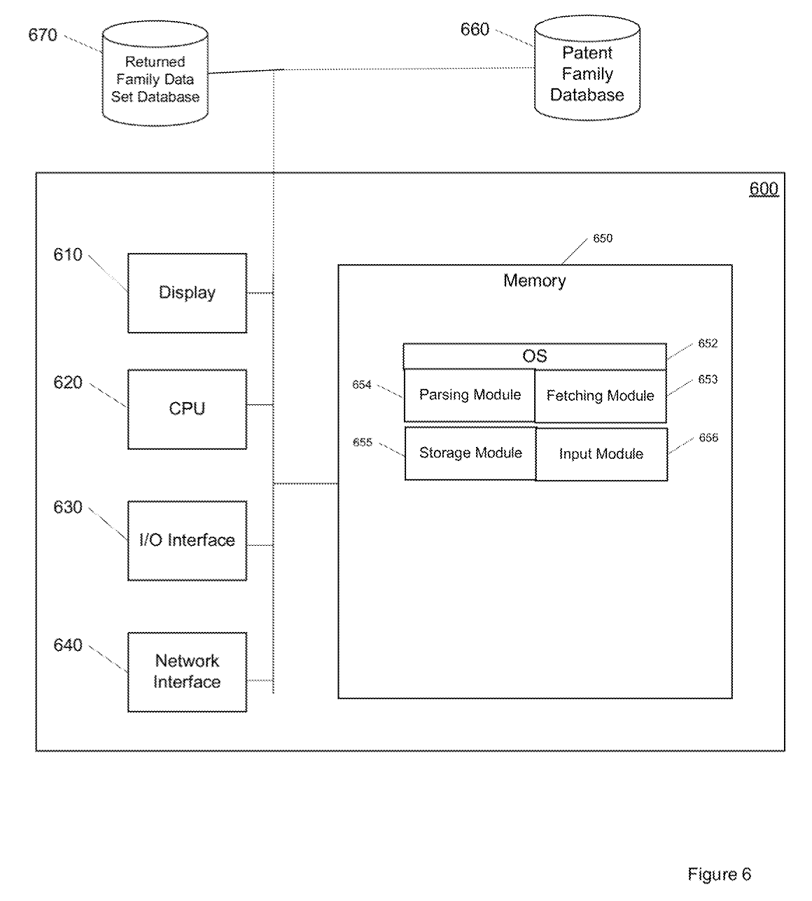

FIG. 1 is a flow-chart of a method of analyzing patent families consistent with the present invention. A patent family analysis platform 600 (shown in FIG. 6) receives a set of one or more patent publication numbers (stage 110). The patent publication numbers may represent either issued patents or published patent applications. Furthermore, the term “patent publication number” means any reference number utilized to identify a patent or a published patent application. The patent family analysis platform 600 may access a patent family database 660 (illustrated in FIG. 6), either external or internal, to retrieve a family data set for one or more of the patent publication numbers (stage 120). A family data set may be comprised of a plurality of family member data sets. The family member data sets may contain information on related patents. For example, the family member data set may contain a publication number and one or more of the following information for the respective publication number: country, publication date, application number, application date, priority number, and priority date. In addition, the family member data set may contain one or more of the following pieces of patent data for a respective publication number: title, abstract, issue date, inventor, assignee, applicant, international patent classification, and U.S. patent classification.

After patent family analysis platform 600 retrieves the family data set, platform 600 may store the family data set in a returned family data set database 670 (illustrated in FIG. 6) (stage 130). The family data set may be used by platform 600 to graphically display relationships within the family data set to a user (stage 640). Graphically displaying may include, for example, displaying in chart, bar graph, pie chart, or table forms. For example, platform 600 may display a table illustrating countries where family members have been filed; a table illustrating patent family members by patent classification; or a table illustrating patent family members by filing date, publication date, or issue date. These are mere examples, and those skilled in the art having read this disclosure will appreciate the variations of useful family information that can be displayed. Furthermore, those skilled in the art will appreciate that graphical forms other than tables can be used. For example, bar charts, pie charts, and scatter plots could all illustrate family data sets.

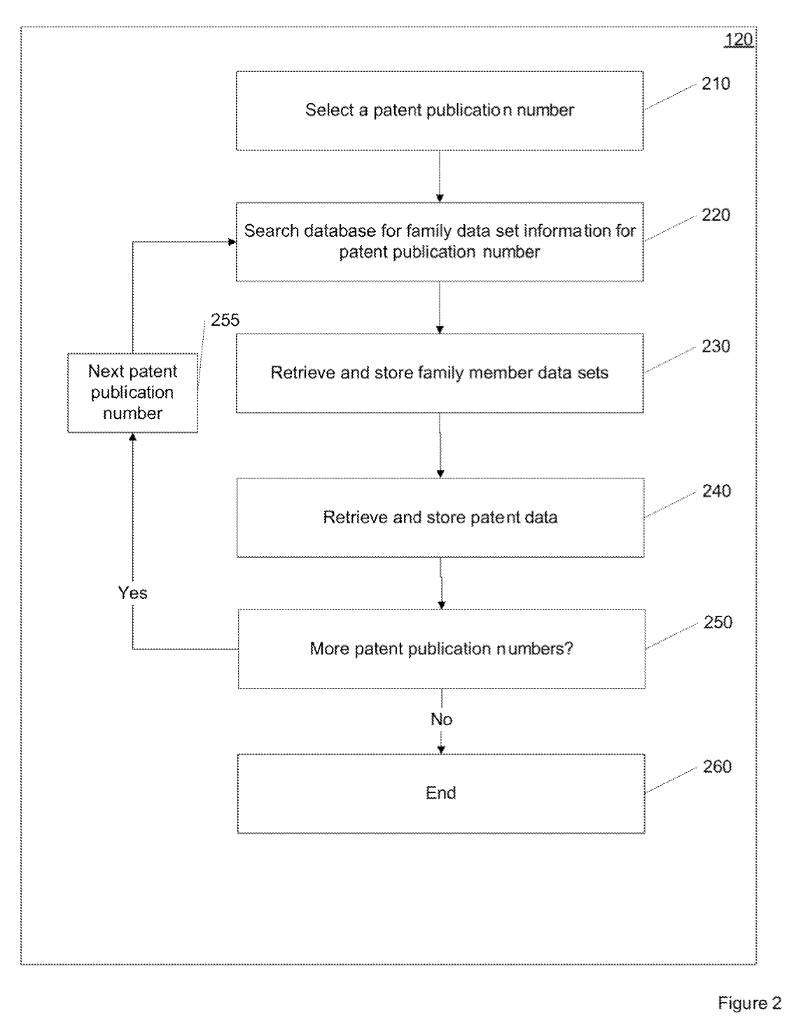

FIG. 2 is a flow-chart of a method of retrieving patent family data sets consistent with the present invention. Platform 600 selects a first patent publication number supplied to it (stage 210). Platform 600 searches patent family database 660 for family member data sets of related patent publications (stage 220). Family member data sets are retrieved from patent family database 660 and stored in returned family data set database 670 (stage 230). Platform 600 may also retrieve patent data from a patent database and store the patent data in patent family database 660 (stage 240). If there are no more received patent publication numbers (stage 250), the method 120 is complete (stage 260). If there are additional patent publication numbers, the next patent publication number is selected (stage 255) and method 120 continues at stage 220.

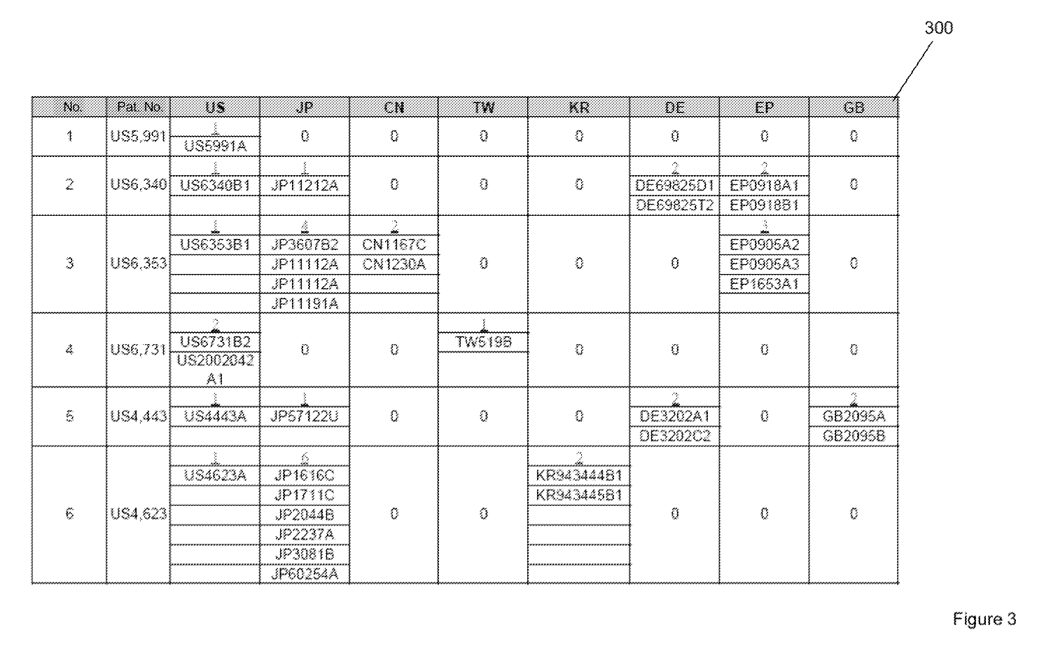

FIG. 3 is a graphical display of patent family data illustrating the count and publication number of patent family members consistent with the present invention. Table 300 is an exemplary illustration of graphically displayed patent family data. In table 300, platform 600 has received 6 patent publication numbers. The patent publication numbers are listed in the second column. Each column then contains the number of patent family members in each of the countries listed at the top of each respective column. In addition, each component of the table also contains the publication number of each patent family member. For example, the second row of the table illustrates that U.S. Pat. No. 6,340 has 6 family members: 1 U.S., 1 Japanese, 2 German, and 2 EPO publications.

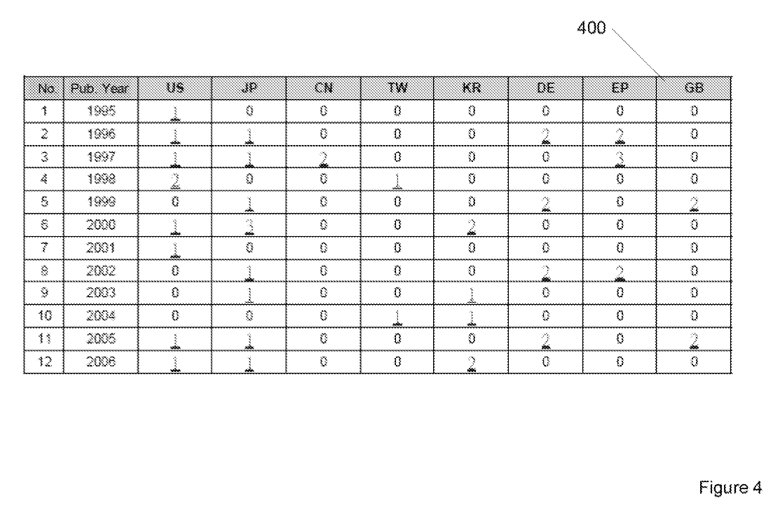

FIG. 4 is a graphical display of patent family data illustrating the issue dates of patent family members consistent with the present invention. Table 400 is another illustration of an exemplary graphical display. Table 400 shows for a given patent family, or set of patent families, the number of patent publications in a range of countries over a period of time from 1995 to 2006. Table 400 shows a number in each component of the table, but could also illustrate, in place of or in addition to the count of patent publications, the patent publication number. Thus, table 400 illustrates to a user the temporal and geographic scope of patent protection for one or more patent families.

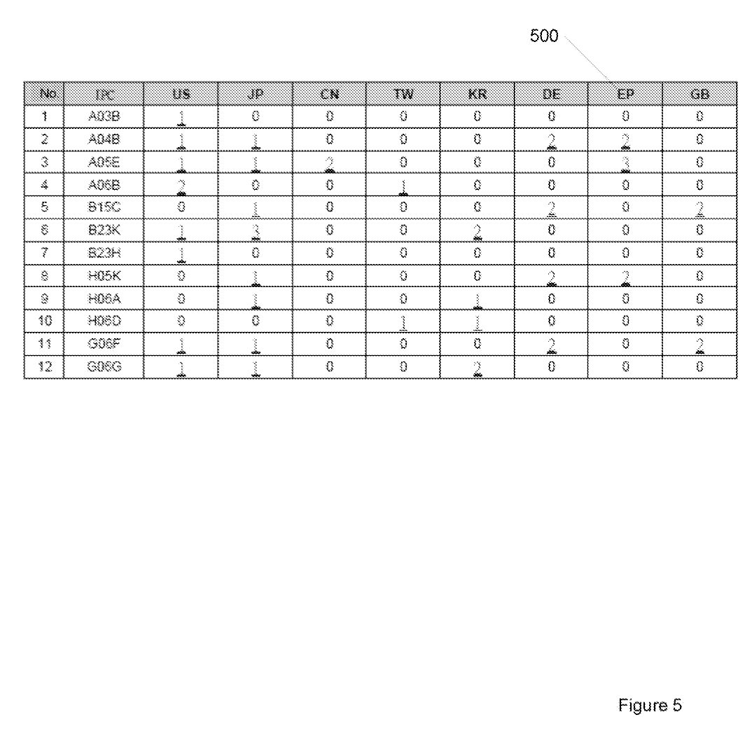

FIG. 5 is a graphical display of patent family data illustrating the international patent classification number of patent family members consistent with the present invention. Table 500 is another illustration of an exemplary graphical display. Table 500 shows for a given patent family, or set of patent families, the number of patent publications in a range of countries for a range of technologies denoted by international patent classification codes. Table 500 shows a number in each component of the table, but could also illustrate, in place of or in addition to the count of patent publications, the patent publication number. Thus, table 500 illustrates to a user the technological and geographic scope of patent protection for one or more patent families.

FIG. 6 is a block diagram of a patent family analysis platform consistent with the present invention. As illustrated in FIG. 4, a system environment of patent family analysis platform 600 may include a display 610, a central processing unit 620, an input/output interface 630, a network interface 640, and memory 650 coupled together by a bus. Patent family analysis platform 600 may be adapted to include the functionality and computing capabilities to analyze patent family deployment and characteristics.

As shown in FIG. 6, patent family analysis platform 600 may comprise a PC or mainframe computer for performing various functions and operations consistent with the invention. Patent family analysis platform 600 may be implemented, for example, by a general purpose computer selectively activated or reconfigured by a computer program stored in the computer, or may be a specially constructed computing platform for carrying-out the features and operations of the present invention. Patent family analysis platform 600 may also be implemented or provided with a wide variety of components or subsystems including, for example, at least one of the following: at least one central processing units 620, a co-processor, memory 650, registers, and other data processing devices and subsystems.

Patent family analysis platform 600 may also communicate or transfer family data set information, family member data sets, or stored family data sets via I/O interface 630 and/or network interface 640 through the use of direct connections or communication links to other elements of the present invention. For example, a firewall in network interface 640, prevents access to the platform by unauthorized outside sources.

Alternatively, communication within patent family analysis platform 600 may be achieved through the use of a network architecture (not shown). In an alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, patent family analysis platform 600 may be located in the same location or at a geographically distant location from patent family database 660 and returned family data set database 670.

I/O interface 630 of the system environment shown in FIG. 6 may be implemented with a wide variety of devices to receive and/or provide the data to and from patent family analysis platform 600. I/O interface 630 may include an input device, a storage device, and/or a network. The input device may include a keyboard, a microphone, a mouse, a disk drive, video camera, magnetic card reader, or any other suitable input device for providing data to patent family analysis platform 600.

Network interface 640 may be connected to a network, such as a Wide Area Network, a Local Area Network, or the Internet for providing read/write access to data in assignment database 660 and returned patent database 670.

Memory 650 may be implemented with various forms of memory or storage devices, such as read-only memory (ROM) devices and random access memory (RAM) devices. Memory 650 may also include a memory tape or disk drive for reading and providing records on a storage tape or disk as input to patent family analysis platform 600. Memory 650 may comprise computer instructions forming: an operating system 652; a parsing module 654 for parsing queries to and from HTML; a fetching module 653 for retrieving family member data sets records from patent family database 660 and for retrieving additional family member data from a patent database (not shown); a storage module 655 for storing retrieved family data sets to retrieved family data set database 670; and an input module 656 for receiving the set of patent publication numbers.

Patent family database 660 is coupled to patent family analysis platform 600. Patent family database 660 may be, for example, located on servers at the U.S.P.T.O. (USPTO assignment records database or P.A.I.R.), the E.P.O. (espacenet), or through commercial services, such as Derwent's World Patent Index. Patent family database 660 may be electronic memory, magnetic memory, optical memory, or a combination thereof, for example, SDRAM, DDRAM, RAMBUS RAM, ROM, Flash memory, hard drives, floppy drives, optical storage drives, or tape drives. Patent family database 660 may comprise a single device, multiple devices, or multiple devices of multiple device types, for example, a combination of ROM and a hard drive.

Retrieved family data set database 670 is coupled to patent family analysis platform 600. A database of tables of family data sets may be stored in retrieved family data set database 670. Retrieved family data set database 670 may comprise, for example, a spreadsheet as well as a traditional database. Retrieved family data set database 670 may also be stored in memory 650, and not as an external database. Retrieved family data set database 670 may be electronic memory, magnetic memory, optical memory, or a combination thereof, for example, SDRAM, DDRAM, RAMBUS RAM, ROM, Flash memory, hard drives, floppy drives, optical storage drives, or tape drives. Retrieved family data set database 670 may comprise a single device, multiple devices, or multiple devices of multiple device types, for example, a combination of ROM and a hard drive.

Those skilled in the art will appreciate that all or part of systems and methods consistent with the present invention may be stored on or read from other computer-readable media, such as: secondary storage devices, like hard disks, floppy disks, flash storages, CD, or DVD; a carrier wave received from the Internet; or other forms of computer-readable memory, such as read-only memory (ROM), random-access memory (RAM), or magnetic RAM.

Furthermore, one skilled in the art will also realize that the processes illustrated in this description may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

We claim:

1. A method for analyzing patent families, the method comprising:
receiving a patent publication number;
retrieving a family data set for the patent publication number, where the family data set includes a plurality of family member data sets, where each family member data set is related to the patent publication number and where each family member data set includes a publication number and country;
storing the family data set; and
graphically displaying a relationship between two or more of the plurality of family.

2. The method of claim 1, wherein retrieving the family member data set comprises retrieving every family member data set where the family member data set is related to the patent publication number.

3. The method of claim 1, further comprising:
retrieving patent data for at least two or more of the plurality of family member data sets, where patent data is selected from the group consisting of title, abstract, issue date, inventor, assignee, applicant, international patent classification, and U.S. patent classification; and
storing the retrieved patent data.

4. The method of claim 3, wherein the family member data set further includes additional family member data selected from the group consisting of publication data, application number, application date, priority number, and priority date.

5. The method of claim 1, wherein graphically displaying the relationship between two or more of the plurality of family member data sets further comprises displaying a table having a matrix displaying the received patent publication number on a first axis and one or more countries on a second axis, and where the each component of the matrix indicates a count of family member data sets having a country matching the country of the associated country on the second axis.

6. The method of claim 1, wherein graphically displaying the relationship between two or more of the plurality of family member data sets further comprises displaying a table having a matrix displaying the received patent publication number on a first axis and one or more countries on a second axis, and where the each component of the matrix indicates the publication number of the family member data set having a country matching the country of the associated country on the second axis.

7. The method of claim 1, wherein graphically displaying the relationship between two or more of the plurality of family member data sets further comprises displaying a table having a matrix displaying the received patent publication number on a first axis and one or more countries on a second axis, and where the each component of the matrix indicates the publication number of the family member data set having a country matching the country of the associated country on the second axis, and wherein each component further includes a count of family member data sets having a country matching the country of the associated country on the second axis.

8. The method of claim 4, wherein graphically displaying the relationship between two or more of the plurality of family member data sets further comprises displaying a table having a matrix displaying a patent criteria selected from issue date, international patent classification, U.S. patent classification, publication data, application date, and priority date on a first axis and one or more countries on a second axis, and where the each component of the matrix indicates a count of family member data sets matching the patent criteria and having a country matching the country of the associated country on the second axis.

9. The method of claim 4, wherein graphically displaying the relationship between two or more of the plurality of family member data sets further comprises displaying a table having a matrix displaying a patent criteria selected from issue date, international patent classification, U.S. patent classification, publication data, application date, and priority date on a first axis and one or more countries on a second axis, and where the each component indicates the publication number of family member data sets matching the patent criteria and having a country matching the country of the associated country on the second axis.

10. A system for analyzing patent families, comprising:
a memory;
a processor coupled to the memory, the processor operable to:
receiving a patent publication number;
retrieve a family data set for the patent publication number, where the family data set includes a plurality of family member data sets, where each family member data set is related to the patent publication number and where each family member data set includes a publication number and country;
store the family data set; and
graphically display a relationship between two or more of the plurality of family member data sets in the family data set.

11. The system of claim 10, the processor further operable to retrieve every family member data set where the family member data set is related to the patent publication number.

12. The system of claim 10, the processor further operable to:
retrieve patent data for at least two or more of the plurality of family member data sets, where patent data is selected from the group consisting of title, abstract, issue date, inventor, assignee, applicant, international patent classification, and U.S. patent classification; and store the retrieved patent data.

13. The system of claim 12, wherein the family member data set further includes additional family member data selected from the group consisting of publication data, application number, application date, priority number, and priority date.

14. The system of claim 1, the processor further operable to display a table having a matrix displaying the received patent publication number on a first axis and one or more countries on a second axis, and where the each component of the matrix indicates a count of family member data sets having a country matching the country of the associated country on the second axis.

15. The system of claim 10, the processor further operable to display the relationship between two or more of the plurality of family member data sets further comprises displaying a table having a matrix displaying the received patent publication number on a first axis and one or more countries on a second axis, and where the each component of the matrix indicates the publication number of the family member data set having a country matching the country of the associated country on the second axis.

16. The system of claim 10, the processor further operable to display a table having a matrix displaying the received patent publication number on a first axis and one or more countries on a second axis, and where the each component of the matrix indicates the publication number of the family member data set having a country matching the country of the associated country on the second axis, and wherein each component further includes a count of family member data sets having a country matching the country of the associated country on the second axis.

17. The system of claim 13, wherein the processor is further operable to display a table having a matrix displaying a patent criteria selected from issue date, international patent classification, U.S. patent classification, publication data, application date, and priority date on a first axis and one or more countries on a second axis, and where the each component of the matrix indicates a count of family member data sets matching the patent criteria and having a country matching the country of the associated country on the second axis.

18. The system of claim 13, wherein the processor is further operable to display a table having a matrix displaying a patent criteria selected from issue date, international patent classification, U.S. patent classification, publication data, application date, and priority date on a first axis and one or more countries on a second axis, and where the each component indicates the publication number of family member data sets matching the patent criteria and having a country matching the country of the associated country on the second axis.
